(19) United States
(12) Patent Application Publication
(10) Pub. No.: US 2011/0135288 A1
(43) Pub. Date: Jun. 9, 2011

(54) Furnace for Conditioning Preforms

(75) Inventors: Frank Winzinger, Regensburg (DE); Wolfgang Schonberger, Brennberg (DE); Christian Holzer, Schierling (DE); Konrad Senn, Regensburg (DE); Andreas Wutz, Roding (DE)

(73) Assignee: KRONES AG, Neutraubling (DE)

(21) Appl. No.: 12/959,411

(22) Filed: Dec. 3, 2010

(30) Foreign Application Priority Data
Dec. 4, 2009 (DE) 102009047536.2

(51) Int. Cl. F27D 11/00; F24C 7/04

(52) U.S. Cl. 392/416; 219/422

(57) ABSTRACT

A furnace for conditioning preforms with several heating chambers rotating in a circle for heating one preform each with infrared radiation, and having holding devices for holding the preforms during heating, so that a section of the preform to be conditioned is essentially arranged in the heating chamber, and a section not to be conditioned is arranged outside the heating chamber. Accordingly, the section to be conditioned can be heated in a controlled and effective manner, and the section not to be conditioned can be protected from undesired heating.

### CROSS-REFERENCE TO RELATED APPLICATION

The present application claims the benefit of priority of German Application No. 102009047536.2, filed Dec. 4, 2009. The entire text of the priority application is incorporated herein by reference in its entirety.

### FIELD OF THE DISCLOSURE

The disclosure relates to a furnace for conditioning preforms, such as by infrared radiation, such as used in preparing molded containers used in bottling operations.

### BACKGROUND

Containers to be manufactured by blow molding or stretch blow molding are shaped from so-called preforms that have to be heated to a desired process temperature before the actual blowing procedure. To be able to reshape, during blow molding, the rotationally symmetric preforms, which normally have standardized wall thicknesses, to containers having a certain shape and wall thickness, individual wall regions of the preform must be subjected to dosed heating in a furnace, preferably with infrared radiation. To this end, usually a continuous stream of preforms is passed through a furnace with correspondingly adapted radiation sections. It is, however, a problem of such furnaces to selectively introduce a maximum proportion of the radiated thermal output into the preforms.

As an alternative, patent publication DE 10 2006 015853 A1 suggests to heat preforms in individual radiation chambers that each completely surrounds the preforms, the individual chambers being arranged like a carrousel. In the process, each preform is heated both by the inner wall of the chamber embodied as ceramic infrared radiator and by a rod-shaped infrared radiator which is introduced into the preform. As can be taken from a schematic representation of DE 10 2006 015853 A1, the preform is completely introduced into the radiation chamber in the process. Here, however, a problem arises in that an opening region of the preform which is not to be deformed in the subsequent blow molding process must not be heated, or must not be heated to the same extent as the other wall sections of the preform. Thus, there is a need for a furnace improved in this respect.

### SUMMARY OF THE DISCLOSURE

It is thus one aspect of the disclosure to provide a furnace with separate radiation chambers which permits a dosed radiation of individual wall areas of the preforms.

This aspect is achieved with a furnace comprising a holding device for holding the preforms during heating to arrange a section of the preform to be conditioned essentially in the heating chamber and a section not to be conditioned outside the heating chamber, the section to be conditioned can be heated selectively and with an increased efficiency. At the same time, the shape and stability of the section not to be conditioned can be maintained.

In an advantageous embodiment, the heating chambers have an oval, in particular elliptical cross-section, or a polygonal, in particular rectangular cross-section, and/or the holding devices are embodied to hold the section of the preform to be conditioned each eccentric with respect to the cross-section of the heating chamber. Thereby, the preform can be radiated and heated rotationally symmetrically and prepared for blowing correspondingly asymmetric containers. Thereby, “Preferential Heating” is even permitted without rotation of the preform along heater segments that have varying radiation powers around the circumference. However, oval and polygonal cross-sections could also be combined with a rotation of the preform with respect to the heating chamber. Oval cross-sections in the sense of the disclosure include the combination of straight circumferential sections and segments of a circle, such as for example rounded rectangles. Preferably, suited cross-sections comprise a main axis and a minor axis, for example with elliptical cross-sections, or long and short sides, such as for example with rectangular cross-sections.

Preferably, the heating chamber and/or the holding device are mounted to rotate essentially about the main axis of the preform to adjust, in particular change continuously, the rotational position of the preform with respect to the heating chamber during heating. Thereby, the preform can be heated uniformly around the circumference. As an alternative, it is possible to purposefully align circumferential partial areas of the preform with respect to circumferential partial areas of the heating chamber to heat it selectively.

A particularly advantageous embodiment furthermore comprises a central drive device for rotating the holding devices, the central drive device in particular comprising meshing gearwheels connected with the holding devices with torque transmission. The connection with torque transmission can comprise shafts, gearwheels and the like to transmit a driving torque from the drive device to the holding devices. The central drive device preferably rotates together with the heating chambers. It would also be conceivable for the central drive device to comprise gearwheels or the like which are connected with the holding devices with torque transmission but which do not mesh, as well as a belt rotating around the circumference of the gearwheels to drive them together. The central drive device comprises at least one motor which can rotate with the central drive device or be stationary. The motor could be attached to a heating wheel radially outside or inside. The term “central” is to be understood in the sense of “common for several heating chambers”.

A particularly advantageous embodiment of the disclosure furthermore comprises: spline or splined shafts for torque transmission from the central drive device to the holding devices; and lifting devices for lifting/lowering the holding devices along the spline or splined shafts. Thereby, the preforms can be lowered along the spline shaft or splined shaft from a transfer position to a radiation position towards the heating chambers. In other words, the transfer of the preforms into the furnace or out of the furnace with corresponding grippers or the like is not hindered by the rotary drive of the preform and/or an internal infrared heater. It is in particular possible to dispose the central drive unit in an upper region of the heating wheel where no preforms are transferred, and to transmit the torque for driving the holding devices by the spline shaft or splined shaft to a region where the preforms are transferred, and furthermore to a region located thereunder where the preforms are radiated. To this end, the spline shaft or splined shaft is preferably vertically firmly connected to the holding device and movably mounted in a sliding guide provided at the central drive unit, for example a hub, to transmit torque.

In a preferred embodiment, the holding device comprises a bearing plate for a supporting ring embodied at the preform, a drive mechanism, in particular a circumferential toothing and/or a decentralized electric drive, being embodied at the holding device for rotating the preform. Thereby, the preform can be held at a region not to be conditioned to rotate the region to be conditioned in a defined manner and shield the region not to be conditioned from infrared radiation. Such an arrangement can be constructively particularly easily realized.

Preferably, the holding device comprises a receiving sleeve which surrounds the heating chamber at least partially circumferentially and is connected to the bearing plate by a releasable coupling, the drive mechanism being provided at the receiving sleeve. Thereby, the drive mechanism can be provided at a site that does not or only slightly restrict the accessibility of the heating chamber during loading or during the withdrawal of the preform. The preferably axially releasable coupling permits a quick exchange of the bearing plate and simultaneously permits a stable mount with respect to the rotational position of the preform.

In a preferred embodiment, the holding device furthermore comprises a pressing device which can be engaged with an opening section provided at the preform to press the preform with the supporting ring against the bearing plate, the drive mechanism being provided at the pressing device. Thereby, the preform can be simultaneously fixed and rotated at the holding device.

In a preferred embodiment, the holding device comprises a retaining pin for engagement in an opening region provided at the preform, a drive mechanism, in particular a circumferential toothing and/or a decentralized electric drive, being embodied at the heating chamber for rotating the heating chamber. Thereby, a particularly stable fixing of the preform with respect to the axis of revolution can be obtained.

Preferably, the heating chamber holds at least one essentially annular or ring segment-shaped external infrared heater for radiating the outer wall of the preform. Thereby, the wall of the preform can be heated particularly uniformly and with high efficiency.

Preferably, the furnace furthermore comprises an axially adjustable and essentially rod-shaped internal infrared heater for radiating the inner wall of the preform. Thereby, the inner wall of the preform can be radiated selectively and with high efficiency, where the axial adjustability facilitates the loading of the heating chamber and permits a selective adaptation of the radiation of the inner wall.

Preferably, the internal infrared heaters, such as for example heating rods, have an oval, in particular elliptical cross-section, or a polygonal, in particular rectangular cross-section, and/or further holding devices are provided to hold the internal infrared heaters each eccentric with respect to the main axis of the preform. Equally, the preform could be held eccentric with respect to the internal infrared heater and the heating chamber. Thereby, the preform can be radiated and heated rotationally asymmetrically and prepared for the blowing of correspondingly asymmetric containers. Thus, “Preferential Heating” is permitted even without rotation of the preform or the internal heater. However, eccentric positioning could also be combined with a rotation of the preform or the internal heater. Oval cross-sections in the sense of the disclosure include the combination of straight circumferential sections and segments of a circle, such as for example with rounded rectangles. Preferably, suited cross-sections comprise a main axis and a minor axis, for example with elliptical cross-sections, or long and short sides, such as for example with rectangular cross-sections. The holding device for the internal infrared heater could also be integrated in the holding device for holding the preform.

In a preferred embodiment, circumferential partial areas with different infrared radiations are embodied at the internal and/or external heater, in particular with different radiation performances and/or with different spectral radiation behaviors to heat circumferential partial areas of the preform to different degrees. Thereby, circumferential partial areas of the preform can be selectively prepared for blowing an asymmetric or not rotationally symmetric container.

In a preferred embodiment, the heating chamber comprises at least two chamber segments which are in particular connected by a folding mechanism or a sliding mechanism, the furnace furthermore comprising an operating device for opening and closing the heating chamber by moving the chamber segments apart or towards each other during unloading or loading of the heating chambers. This facilitates lateral loading of the heating chambers.

In a particularly advantageous embodiment: the heating chambers are circumferentially uniformly arranged at a heating wheel mounted to rotate about an axis of rotation; one recess each radially facing outwards with respect to the axis of rotation is embodied in the side wall of the heating chambers; and a circumferentially surrounding bushing is furthermore provided at the furnace and closes the recess in a circumferential partial area of the heating wheel, in particular between a loading area and a withdrawal area, in which one recess each is provided in the bushing, so that the heating chambers are accessible through the recesses of the heating chambers and the bushing for loading them with a preform or withdrawing a preform. Thereby, the heating chambers can be loaded or unloaded laterally, additional mechanisms for opening and closing the heating chambers, for example flaps, being dispensable.

In a further advantageous embodiment: the heating chambers are circumferentially uniformly arranged at a heating wheel mounted to rotate about an axis of rotation; one recess each radially facing inwards with respect to the axis of rotation is embodied in the side wall of the heating chambers; and a central bushing is furthermore provided at the furnace and closes the recess in a circumferential partial area of the heating wheel, in particular between a loading area and a withdrawal area, where one recess each is provided in the bushing, so that the heating chambers are accessible through the recesses of the heating chambers and the bushing for loading them with a preform or withdrawing a preform. Thereby, the heating chambers can be loaded or unloaded laterally, additional mechanisms for opening and closing the heating chambers, for example flaps, being dispensable.

In a particularly advantageous development of the disclosure, a first heating stage is provided in the form of a first group of heating chambers which rotate in a first circle, and a second heating stage is provided in the form of a second group of heating chambers which rotate in a second circle, the holding devices being adapted to hold the preforms in both heating stages during heating. Thereby, the preforms can be held by the holding device successively in different heating stages, for example positioned in their heating chambers, to be able to provide, by the combination of separately adjustable or optimizable heating stages, radiation conditions which are particularly favorable for a certain axial and/or circumferential heat profiling of the preforms.

Preferably, the heating chambers and/or the holding devices are adapted to continuously change the rotational position of the preform with respect to the heating chamber during heating in the first heating stage and to adjust it in alignment during heating in the second heating stage, or vice-versa, so that the preform is heated circumferentially essentially uniformly in the first stage with respect to its main axis, and is heated in the second stage to a higher degree in a first direction perpendicular to the main axis than in a second perpendicular direction, or vice-versa. Thereby, it is possible to uniformly preheat the preforms in the first stage and to purposefully prepare them for blowing a circumferentially asymmetric container shape in the second stage.

Preferably, the infrared radiation in the heating chambers of the first heating stage is essentially distributed such that axial partial areas of the preforms are heated to different degrees, and in the heating chambers of the second stage essentially such that circumferential partial areas of the preforms are heated to different degrees. Thereby, an axial or circumferential heat profiling of the preforms can be performed in separate heating stages and thus be particularly precisely adjusted.

A particularly advantageous embodiment furthermore comprises a first and a second transport device for transporting the heating chambers of the first and the second group, respectively, in a circuit, the transport paths of the transport devices each comprising a section which embodies a segment of a common orbit, the holding devices being arranged on the heating wheel such that they rotate in a circumferential partial section of the heating wheel essentially along the common orbit. Thereby, the furnace can be designed as rotary machine in which the holding devices rotate on an essentially circular path at a constant radial distance from the axis of revolution of the furnace.

### BRIEF DESCRIPTION OF THE DRAWINGS

Preferred embodiments are represented in the drawing. In the drawings:

FIG. 1 shows a schematic plan view of a furnace according to a first embodiment of the disclosure;

FIG. 2 shows a schematic plan view of a furnace according to a second embodiment of the disclosure;

FIG. 3 shows a schematic longitudinal section through a heating chamber of the second embodiment with a rotatable bearing plate for a preform;

FIG. 4 shows a schematic longitudinal section through a heating chamber of the first embodiment with a rotatable and quickly exchangeable bearing plate for a preform;

FIG. 5 shows a schematic partial view of a third embodiment of the furnace according to the disclosure with a rotatable heating chamber;

FIG. 6 shows a schematic cross-section through a radiation arrangement according to the disclosure;

FIG. 7 shows a schematic cross-section through an alternative variant of a radiation arrangement according to the disclosure;

FIG. 8 shows a schematic cross-section of a heating chamber according to the disclosure with a foldable side wall;

FIG. 9 shows a fourth embodiment of the furnace according to the disclosure with a bushing circumferentially surrounding the heating wheel;

FIG. 10 shows a schematic plan view of a fifth embodiment of the furnace according to the disclosure with two successively connected heating stages;

FIG. 11 shows a schematic cross-section through a rotationally asymmetric heating chamber and a rotationally asymmetric heating rod:

FIG. 12 shows a schematic cross-section through a heating chamber with a rotationally asymmetrically positioned preform;

FIG. 13 shows a plan view of a central drive device for holding devices according to the disclosure;

FIG. 14 shows side views of the central drive device with a holding device for a preform in a radiation position and in a transfer position; and

FIG. 15 shows a schematic plan view of a central drive device with a circumferentially rotating drive belt.

### DETAILED DESCRIPTION OF THE PREFERRED EMBODIMENT

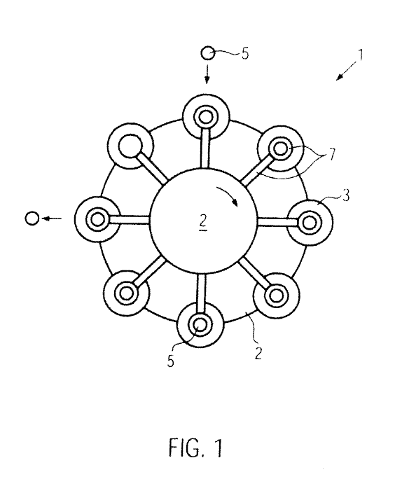

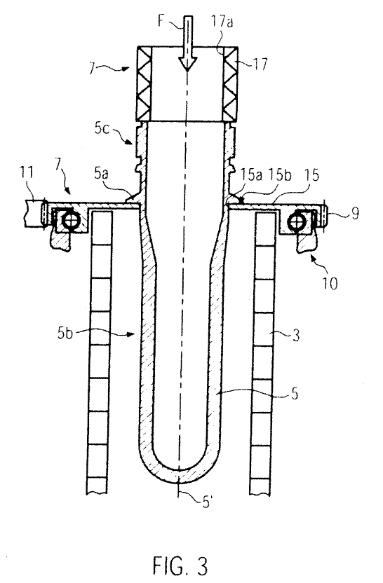

As can be seen in FIG. 1, the first embodiment of the furnace 1 according to the disclosure comprises a heating wheel 2 with heating chambers 3 circumferentially uniformly distributed at the same for heating one preform 5 each, and holding devices 7 for holding the preforms 5. The holding devices 7 are embodied such that they can accept the preforms 5 from a (non-depicted) conventional infeed starwheel, such as a reduction starwheel, or transfer them to a (non-depicted) conventional discharge starwheel. For this, they can comprise, among other things, movable grippers and swiveling and/or lifting mechanisms. The holding device 7 can be moved in the direction of the main axis 5′ of the preform 5 represented in FIG. 3 with a lifting device 13 not represented more in detail to introduce the preform 5 into the heating chamber 3 or withdraw it from the heating chamber 3.

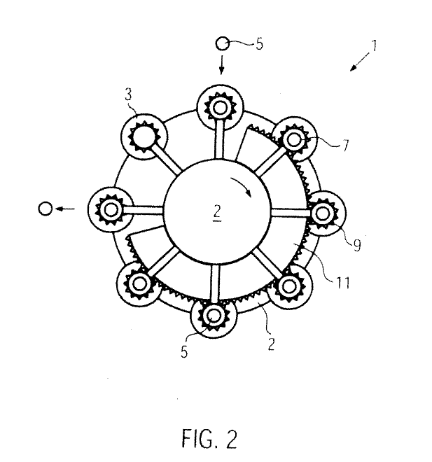

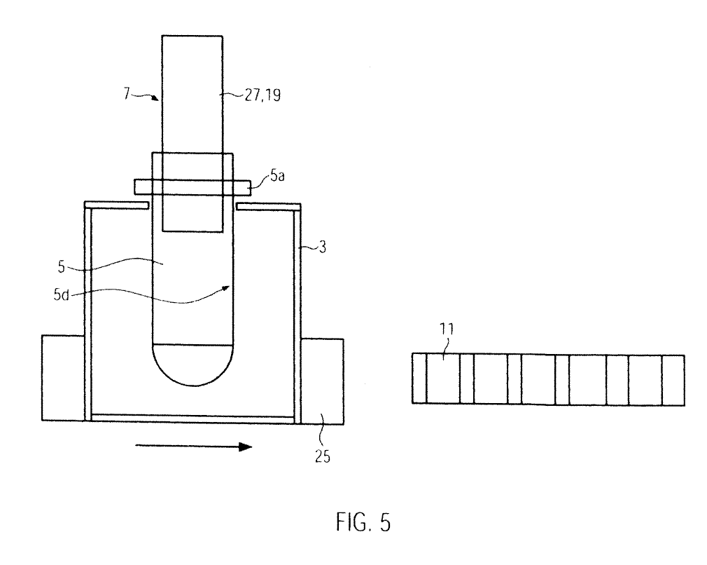

The second embodiment of the furnace 1 represented in FIG. 2 differs from the first embodiment in that the holding devices 7 additionally comprise one drive mechanism 9 each, for example in the form of a circumferential toothing, and a rotatable bearing 10, as represented in FIG. 3, to rotate the preform 5 about its main axis 5′, in particular to adjust or change its rotational position with respect to the heating chamber 3. Correspondingly, a drive device 11 is provided at the heating wheel 2, in the example of FIG. 2 in the form of a stationary crown gear which is engaged with the drive mechanism 9 of the holding devices 7 in a circumferential partial section of the heating wheel 2 to rotate the holding devices 7 or the preforms 5, respectively. In the shown example, the heating chambers 3 are not rotatably mounted. The rotational position of the preforms 5 with respect to the heating chambers 3, however, could also be effected in accordance with FIG. 2 by rotating the heating chambers 3 as will be illustrated more in detail with reference to FIG. 5. The number of heating chambers 3 provided per heating wheel 2 can in practice clearly deviate from the representation in FIGS. 1 and 2.

As is represented in FIG. 3, the holding device 7 according to the disclosure comprises a bearing plate 15 with a central recess 15a through which the preform 5 can be introduced into the heating chamber 3. The recess 15a is dimensioned such that a supporting ring 5a embodied at the preform 5 can be placed onto a bearing region 15b of the bearing plate 15 adjacent to the recess 15a, so that the same supports the preform 5 or acts as stop for the supporting ring 5a in the axial direction towards the heating chamber 3 and centers the preform 5 with respect to the heating chamber 3.

The bearing region 15b is preferably not thicker than 1 mm in the axial direction, so that a maximum proportion of the section 5b of the preform 5 to be conditioned can be arranged within the heating chamber 3. Simultaneously, the section 5c of the preform not to be conditioned, essentially the opening region of the preform 5 or the container to be blown with the supporting ring 5a, is arranged outside the heating chamber 3, the bearing plate 15 also acting as optical and thermal shield against the heating chamber 3. Thus, by engagement of the supporting ring 5a with the bearing surface 15b, a coaxial position of the preform 5 in the heating chamber 3 can be adjusted in a simple and reproducible manner.

The holding device 7 furthermore comprises a pressing sleeve 17 to press the supporting ring 5a against the bearing region 15b. The pressing sleeve 17 transmits a defined contact force F, for example by means of a (non-depicted) pressing spring, onto the opening region 5c of the preform 5 and is provided with a central recess 17a through which a rod-shaped heater 19 (not represented in FIG. 2 for the sake of simplicity) can be introduced into the preform 5.

The drive mechanism 9 provided in the second embodiment is embodied at the bearing plate 15, for example as circumferential toothing. Furthermore, a bearing 10 for the bearing plate 15 is provided at the holding device 7 to permit rotation of the bearing plate 15 essentially about the longitudinal axis 5′ of the preform 5. Furthermore, the drive device 11 is indicated which is stationarily provided at the heating wheel 2 as indicated in FIG. 1. However, it would also be possible to design the drive device 11 in a decentralized manner, for example in the form of individual drive motors associated to the holding devices 7 or the heating chambers 3, respectively. Alternative types of a drive would also be conceivable, such as e.g. belt drives.

In the first embodiment, the driving elements 9, 11 shown in FIG. 3 are not required, the bearing 10 is preferably stationary.

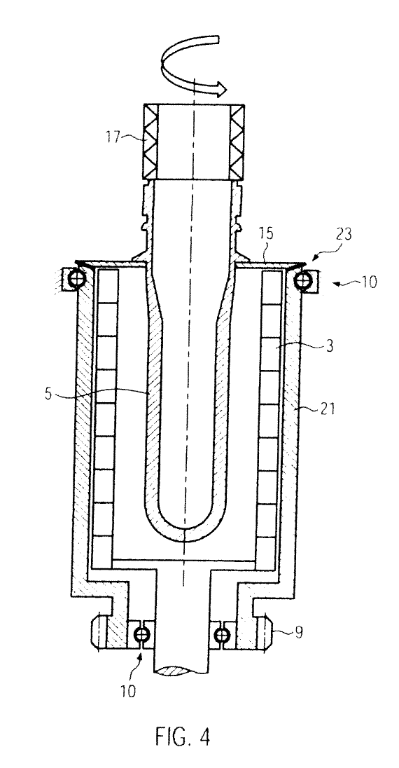

The bearing plate 15 can be designed as fitting especially adapted to certain preforms 5 and be connected to the bearing 10 via a quickly exchangeable coupling, as indicated in FIG. 4, for example via a magnetic coupling. A bayonet-type coupling would also be conceivable.

It would also be possible not to provide the drive mechanism 9 at the bearing plate 15 but at the pressing sleeve 17 (not represented), for example as circumferential toothing which could be engaged with a correspondingly arranged drive device 11 after the heating chamber 3 has been loaded. A direct drive of the sleeve 17 by a motor with a hollow shaft would also be conceivable.

A rotation of the preform 5 or of the heating chamber 3 or the heater 19 is advantageous for uniform heating in the circumferential direction of the preform 5. For this, either the pressing sleeve 17, or the bearing plate 15, or the heating chamber 3 can be rotated. A combined rotation of several components contacting the preform 5 would also be conceivable. The combined rotation could then be performed, for example, in opposite directions. The non-driven parts are preferably rotatably mounted or stationary with respect to the preform 5.

FIG. 4 shows a variant of the second embodiment in which the holding device 7 additionally comprises a receiving bushing 21 connected to the drive mechanism 9 for receiving the heating chamber 3, the bearing plate 15 being connected to the receiving bushing 21 by way of an axially releasable coupling 23, for example by a magnetic coupling. In this case, the drive mechanism 9 is preferably arranged at the end of the receiving bushing 21 opposite to the bearing plate 15, in FIG. 4 at its lower end, while the bearing plate 15 closes the receiving bushing 21 towards the top. Thus, the drive device 11 for the drive mechanism 9 can be arranged in a region of the holding device 7 which does not have to be accessible for loading and unloading the heating chamber 3.

In this variant, the bearing 10 preferably acts directly at the receiving bushing 21, such that the bearing plate 15 can be designed as fitting that can be quickly exchanged. This can be advantageous in particular if different bearing plates 15 for preforms 5 of different dimensions are provided. The receiving bushing 21 can additionally be designed such that it thermally insulates the heating chamber 3 to the outside.

With the bearing of the preform 5 shown in FIGS. 3 and 4, wobbling of the preform 5 can be prevented, which could otherwise, in the worst case, lead to the preform 5 working loose from the holding device 7. Moreover, only a comparably small distance between the rod-shaped heater 19 and the inner wall 5d of the preform 5 is required, so that a particularly precise temperature profiling of the preform 5 is possible.

FIG. 5 shows a schematic partial view of an alternative embodiment of the furnace 1 according to the disclosure in which a drive mechanism 25, for example as surrounding toothing, is provided at the heating chamber 3 to adjust or change a rotational position of the preform 5 with respect to the heating chamber 3. In this case, too, a drive device 11 could be embodied as stationary central gearwheel, as belt drive, or as decentralized drive in the form of individual motors. The bearing of the heating chamber 3 is not represented in FIG. 5 for the sake of simplicity. However, the heating chamber is preferably mounted such that it can be engaged with the drive device 11 while the heating wheel 2 is rotating (in FIG. 5 approximately indicated by an arrow).

For holding the preform 5, the holding device 7 comprises, in contrast to the variants of FIGS. 3 and 4, a retaining pin 27 instead of the bearing plate 15, which can be, for example, provided at the rod-shaped heating element 19 or be formed by the same, and which can be engaged with the inner wall 5d of the preform 5. The retaining pin 27 can comprise a (non-depicted) axial stop mechanism to hold the preform 5 in a defined axial position. Preferably, the outer diameter of the retaining pin 27 is adapted to the inner diameter of the preform 5 such that the preform 5 is seated on the retaining pin 27 in an axially centralized position and secured against tilting. Wobbling of the preform 5, which could in the worst case lead to the preform 5 working loose from the holding device 7, can in this manner be reduced. Moreover, only a comparably small distance between the rod-shaped heater 19 and the inner wall 5d of the preform 5 is required, so that particularly precise temperature profiling of the preform 5 is possible.

It is generally possible to also realize the described variants with decentralized electric drives for each heating chamber 3, each heating rod 19, and/or each bearing plate 15, for example with servomotors or stepper motors.

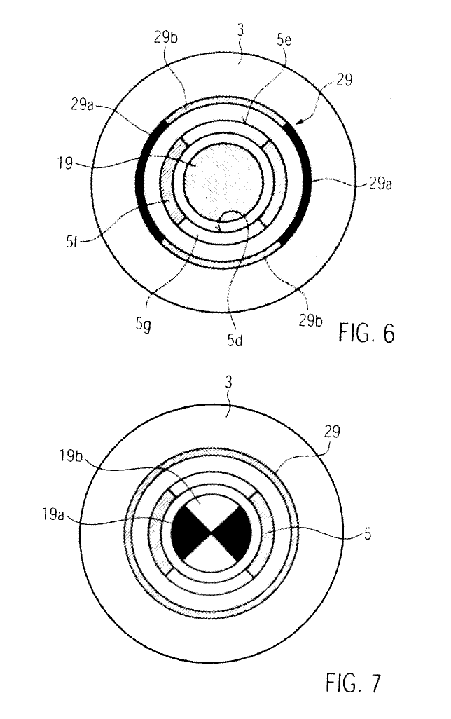

As FIG. 6 illustrates, at least one annular or ring segment-shaped heater 29 for emitting infrared radiation towards the outer wall 5e of the preform 5 is provided in the heating chamber 3. The heater 29 can comprise, for example, segments 29a and 29b that are circumferentially heated to different degrees. Equally, segments 29c and 29d heating to different degrees could be embodied at the heater 29 in the axial direction. The number of circumferential or axial segments 29a to 29d can be adapted in the circumferential or radial direction depending on the desired thermal profiling of the preform 5. For example, as indicated in FIG. 6, opposed segments 29a with a comparably high heating power can be arranged alternating with also opposed segments 29b with a comparably low heating power. In particular with a constant rotational position of the preform 5 in the heating chamber 3, this leads to circumferential partial areas 5f, 5g of the preform 5 being heated to different degrees, so that in a subsequent blowing process, circumferentially asymmetric container shapes with an essentially constant wall thickness can be produced.

Such a configuration is thus suited for so-called “Preferential Heating” to generate, at least in a direction perpendicular to the main axis 5′ of the preform 5, a different wall temperature of the preform 5 than in a second direction also perpendicular to the main axis 5′. The first and the second direction perpendicular to the main axis can be advantageously orthogonal with respect to each other.

The heaters 29 or the segments 29a to 29d could, for example, be designed as functional ceramics actively heated with a heating spiral or as passive functional ceramics which emit thermal radiation with a selected spectral region, or else as heating spiral, for example as omega radiator or partial area of an omega radiator. In the example of FIG. 6, a segmented annular heater 29 is combined with a central heating rod 19. It radiates the inner wall 5d of the preform 5 with a circumferentially essentially uniformly distributed heating power.

As an alternative to this, FIG. 7 shows a heating rod 19 in which circumferential partial areas 19a and 19b of different heating powers are provided. Thereby, with a constant rotational position of the heating rod 19 with respect to the preform 5, circumferential heating of the preform 5 to different degrees can be effected. In FIG. 7, the annular heater 29 is not segmented. However, it would also be possible to combine the segmented heating rod 19 with the segmented design of the ring radiator 29, for example as shown in FIG. 6. Here, it is advantageous though not imperative to orient the segments 19a, 19b, 29a, 29b of the heaters 19 and 29 such that regions 19b, 29b of a comparably low heating power are each situated opposed to regions of a comparably high heating power.

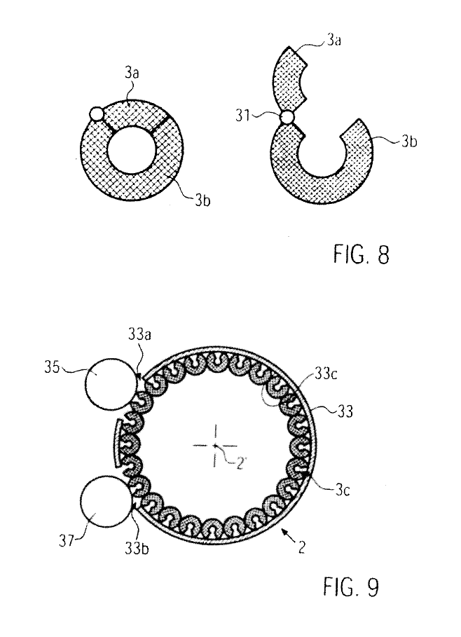

As described above, the holding device 7 can be designed such that loading of the heating chambers 3 or withdrawal of the preforms 5 in the axial direction with respect to the main axis 5′ of the preforms 5 is accomplished by lowering or lifting them. For a transfer of the preforms 5, however, it can be advantageous if they can be introduced into the heating chambers 3 or withdrawn from the same only laterally, that means without any additional lifting motion in the axial direction. To this end, the heating chamber 3 can, as represented in FIG. 8, have a multi-part, in particular two-part design, where the heating chamber 3 can be opened by folding open a section 3a of the heating chamber 3, for example at a hinge 31 which connects the chamber segments 3a, 3b. An actuating mechanism, for example in the form of a mechanical or magnetic cam, can be provided at the furnace 1 to automatically open the section 3a when a loading and withdrawal region of the furnace 1 is reached.

The axis of revolution of the opening mechanism of the heating chamber 3 could also be arranged tangentially to the sense of rotation of the heating chamber 3 in the furnace 1.

Preferably, a portion of the heating chamber 3 is stationarily connected to the heating wheel 2 during the opening movement of the heating chamber 3.

Preferably, a vertical parting plane of the chamber segments 3a, 3b is rotated about a vertical axis with respect to a radial orientation facing outwards, i.e. seen from above, the parting plane faces obliquely in the sense of rotation of the heating wheel 2 or opposite to the sense of rotation. By this, the transfer of the preforms 5 by transport arms is facilitated.

As an alternative, the heating chamber 3 can also be opened by moving apart two halves 3a, 3b or several parts of the heating chamber 3 (not represented).

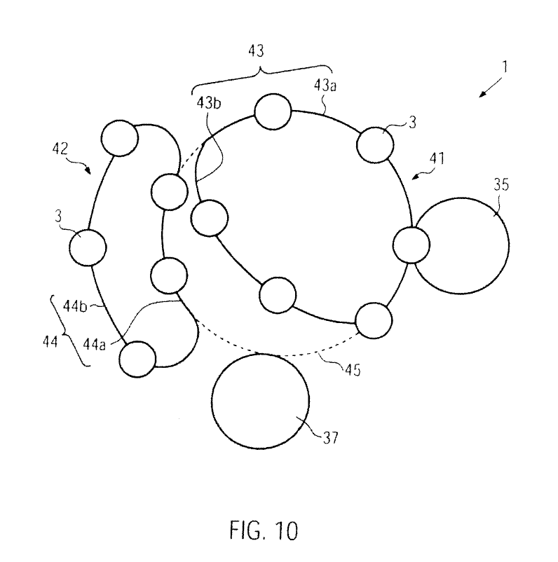

FIG. 9 shows an alternative embodiment of the furnace 1 in which lateral loading of the heating chambers 3 is also possible, and where a recess 3c radially facing outwards with respect to an axis of rotation 2′ of the heating wheel 2 is embodied in the side wall of the heating chambers 3. The heating wheel 2 is furthermore bordered by a surrounding stationary bushing 33 which essentially closes the recesses 3c of the heating chambers 3 to the outside. However, in circumferential partial areas, recesses 33a and 33b for loading or withdrawing the preforms 5 are provided in the bushing 33. The recesses 33a and 33b are preferably located each in a region adjacent to an infeed starwheel 35 or a discharge starwheel 37, respectively, for transferring the preforms 5. The heating chambers 3 are thus laterally or radially accessible while the segments 33a and 33b are passed, so that opening or closing of the heating chambers 3 is possible without employing additional movable closing flaps 3b.

The inner wall 33c of the bushing 33 can be embodied, for example, as a reflector or passive infrared radiator, but an embodiment as active bright or dark radiator is also conceivable. It would also be possible to embody the radiation behavior of the bushing 33 in the axial direction of the preforms 5 differently (in a direction perpendicular to the plane of projection of FIG. 9) to embody an axial temperature profile in the preforms 5. Here, it would be advantageous to let the preform 5 with the holding device 7 rotate with respect to the heating chamber 3.

As an alternative, a (non-depicted) variant could comprise a central stationary bushing which closes recesses of the heating chamber facing inwards in a manner comparable to that with the external bushing 33, in particular between a loading area and a withdrawal area of the furnace 1. The internal bushing could comprise corresponding thermal and optical properties as the external bushing 33. It would also be conceivable to combine external and internal bushings to provide a channel-like border for heating chambers 3 open on both sides. Such borders could only extend across a circumferential partial area of the furnace 1 and be for example arranged successively as segments with different heating properties. The external sleeve 33 or the internal sleeve could also be correspondingly segmented.

FIG. 10 shows another embodiment of the furnace 1 according to the disclosure in which two separate heating stages 41, 42 which the preforms 5 successively pass are provided. In the process, the heating chambers 3 of the heating stages 41 and 42 rotate in separate circuits. The transport paths 43, 44 of the heating stages 41, 42 each comprise at least one area 43a or 44a which embodies a segment of a common circle 45. Correspondingly, the transport paths 43, 44 each extend at least in one further area 43b, 44b not along the circle 45. The transport path of the holding devices 7 (not shown for a better overview) in the plan view essentially extends along the circle 45 or in parallel to it, so that the holding devices 7 can transfer the preforms 5 from the heating stage 41 to the heating stage 42 without leaving their essentially circular transport path. The holding devices 7 can therefore be arranged on the heating wheel 2 in the form of a rotary device. To realize the transport paths 43 and 44 of the heating chambers 3 of the first and the second heating stages 41 and 42, (non-depicted) transport devices 46, 47, such as, for example transfer starwheels, can be for example used with holding arms for the heating chambers 3 swiveling and/or movable by way of cams. The transfer of the preforms 5 to the holding devices 7 or the discharge can be accomplished in a known manner by a conventional infeed starwheel 35 or a discharge starwheel 37.

This embodiment can be particularly advantageously combined with the described variants of the holding device 7 as the holding devices 7 can rotate along a circular transport path also in this two-stage embodiment. The two-stage arrangement is particularly advantageous for optimizing the axial or circumferential profiling of the preforms. This means in each case a certain temperature distribution in the wall of the preform 5 adapted to the subsequent blowing process.

Two heating stages in one heating chamber 3 could also be realized by suited combination of heaters and rotary motions or orientation of the relative rotational position between the preform 5 and the heating chamber 3, for example a uniform, rotationally symmetric preheating, followed by an axial and/or circumferential profiling of the preform 5.

The described embodiments can be arbitrarily combined. In particular, the described variants of the holding devices 7 can be arbitrarily combined with the described variants of the heating chamber 3 and the heating rod 19 as well as with the embodiments of the furnace 1 described in connection with FIGS. 8 to 10. A change of the rotational position between the preform and the heating chamber or the heating rod can be advantageous depending on the demands, but is not imperative.

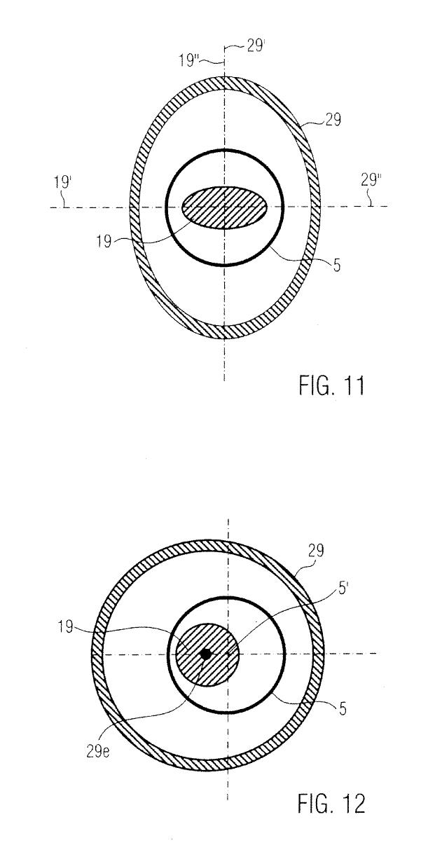

FIG. 11 shows a further embodiment of the disclosure advantageous for “Preferential Heating” by means of which advantages similar to those with the embodiments represented in FIGS. 6 and 7 can be obtained. As FIG. 11 indicates, circumferential heating to different degrees can be obtained by heaters 29 and/or heating rods 19 having a rotationally asymmetric cross-section. Suited cross-sectional shapes are for both heating elements oval, in particular ellipses with a suited aspect ratio of the main axes 29′, 19′ and the minor axis 29″, 19″ of the heaters 29, 19. Rectangular cross-sections (not shown) with differently long sides, or correspondingly shaped other polygons are also conceivable. With such asymmetric shapes of the heaters 29 and/or heating rods 19, the preform 5 is preferably not rotated during radiation or only rotated for a portion of the radiation duration. The main axis 29′ and the minor axis 19″ as well as the main axis 19′ and the minor axis 29″, however, do not have to overlap as in the shown example. The rotational positions of the heaters 19, 29 could also be varied with respect to each other.

Similar, circumferentially non-uniform temperature profiles in the heated preform 5 can also be obtained by asymmetrically positioning the main axis 5′ of the preform 5 with respect to the heater 29 and/or the heating rod 19, as indicated in FIG. 12. Here, it would be also possible to asymmetrically arrange the preform 5 only with respect to the cross-section of the external heater 29 and the corresponding heating chamber 3, or only with respect to the cross-section of the heating rod 19. With such asymmetric positioning, the preform 5 is preferably neither rotated during radiation, or only during a portion of the radiation duration.

Of course, it would also be possible to combine the radiation arrangements of FIGS. 11 and 12. That means one could combine rotationally asymmetric radiator shapes with an asymmetric positioning of the preform 5 with respect to the respective radiator cross-section. In particular with asymmetric radiator cross-sections, one could define the asymmetry of the positioning with respect to a cross-sectional center 29e of the external heater 29 and/or the heating rod 19 (not shown).

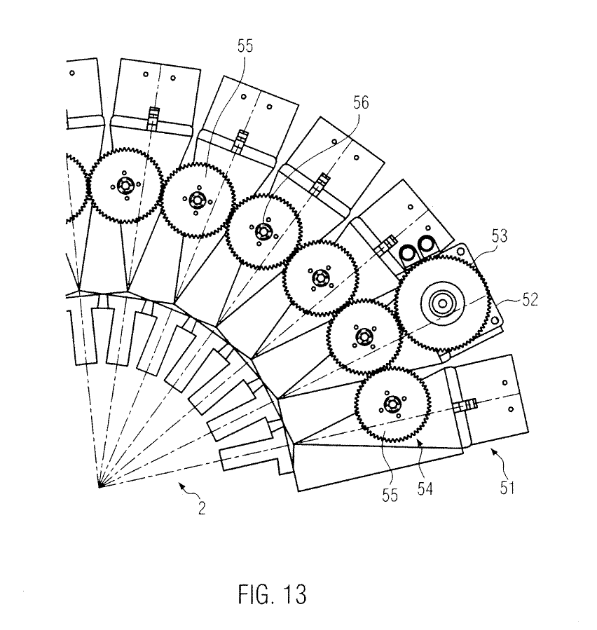

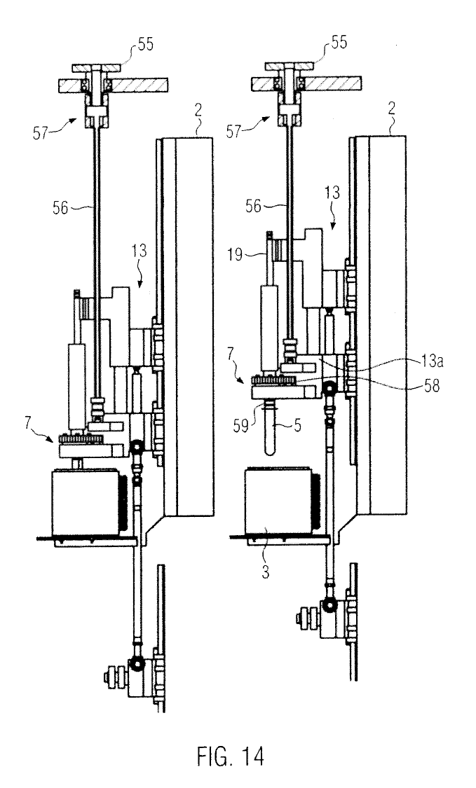

FIGS. 13 and 14 show a further preferred embodiment of the disclosure, in which a central drive unit 51 for the common rotary drive of the holding devices 7 is provided at the heating wheel 2. The drive unit 51 comprises a motor 52 rotating along with a gearwheel 53 or the like which engages a gearwheel chain 54 and drives the same. The latter is formed of gearwheels 55 which are each associated to one holding device 7 and mesh with each other, so that they mutually drive each other like a chain, in the example with alternating moving directions. Thus, one single drive unit is sufficient, namely the motor 52, to drive all holding devices 7 provided at the heating wheel 2 and rotate the preforms 5 with respect to the associated heating chambers 3.

FIG. 14 moreover illustrates that between the gearwheels 55 and the holding devices 7, one spline shaft 56, splined shaft or the like each is provided and transmits a torque from the respective associated gearwheel 55 to the holding device 7 mounted thereunder at a lifting device 13. The change of the holding device 7 and the preform 5 from a radiation position shown in the left of FIG. 13 to a transfer position shown in the right is accomplished by lifting a slide 13a of the lifting device 13.

As FIG. 14 furthermore shows, the spline shaft 56 is axially mounted at the slide 13a and thus coupled to the holding device 7 in the vertical direction. The spline shaft 56 is furthermore movably mounted in a sliding seat with torque transmission, such as for example a hub 57 of the gearwheel 55. Thereby, the spline shaft 56 can transmit, independent of the lift of the lifting device 13, a torque from the gearwheel 55 to the holding device 7. At the latter, a transmission gearwheel 58 is provided in the shown example, so that a preferably resiliently pretensioned hollow shaft 59 is employed in the holding device 7, for example a collet chuck engaging in the opening section 5c, through which the heating rod 19 can be introduced into the preform 5. Thus, the changes of position required for the change between the transfer position and the radiation position, and a lateral access (in FIG. 14 from the left) required for the transfer of the preform 5 to the holding device 7 can be ensured without having to decouple the rotary drive of the holding device 7 from the central drive unit 51.

Thereby, not only costs for additional actuators and control units can be saved. It is also possible to arrange sensitive active system components remote from the heated areas of the heating chambers 3 and the heating rods and thereby increase the reliability of the furnace according to the disclosure.

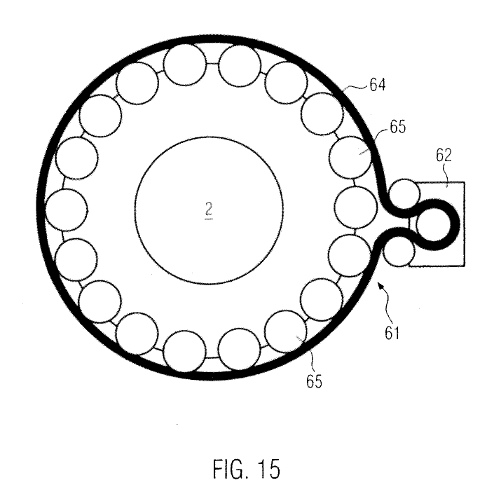

FIG. 15 shows a further variant of a central drive unit 61, in which a motor 62 and gearwheels 65, frictional wheels, or the like associated to the holding devices 7 are also provided. Equally, the lifting mechanism 13 including the spline shaft 56 and the hub 57 could also be used in this embodiment (not shown). The gearwheels 65, however, do not mesh with each other but are connected with a common externally rotating drive belt 64 which is in turn driven by the motor 62. The motor 62 could to this end also rotate with the heating wheel 2, or else be stationary. The drive belt 64 has the advantage that a lower demand with respect to accuracy is put on the gearwheels 65 and thus manufacture and maintenance costs due to wear can be saved.

The embodiments described in FIGS. 11 to 15 can also be arbitrarily combined in a technically advantageous manner with each other or with other variants of the furnace according to the disclosure.

1. Furnace for conditioning preforms, in particular for stretch blow molding plastic containers, comprising a plurality of heating chambers rotating in a circle for heating one preform each with infrared radiation, holding devices for holding the preforms during heating such that a section of the preform to be conditioned is arranged in a heating chamber, and a section of the preform not to be conditioned is arranged outside the heating chamber.

2. Furnace according to claim 1, wherein the heating chambers have an oval cross-section or a polygonal cross-section, and/or that the holding devices are embodied to hold the section of the preform to be conditioned each eccentric with respect to the cross-section of the heating chamber.

3. Furnace according to claim 1, wherein the heating chamber and/or the holding device are essentially mounted to rotate about the main axis of the preform to adjust the rotational position of the preform with respect to the heating chamber during heating.

4. Furnace according to claim 3, and a central drive device for rotating the holding devices.

5. Furnace according to claim 4, and one of spline or splined shafts for torque transmission from the central drive device to the holding devices, and by lifting devices for lifting/lowering the holding devices along the spline or splined shafts.

6. Furnace according to claim 3, wherein the holding device comprises a bearing plate for a supporting ring embodied at the preform, and that a drive mechanism is embodied at the holding device for rotating the preform.

7. Furnace according to claim 6, wherein the holding device comprises a receiving sleeve which surrounds the heating chamber at least partially circumferentially and is connected with the bearing plate by a releasable coupling, the drive mechanism being provided at the receiving sleeve.

8. Furnace according to claim 6, wherein the holding device further comprises a pressing device which can be engaged with an opening section provided at the preform to press the preform with the supporting ring against the bearing plate, the drive mechanism being provided at the pressing device.

9. Furnace according to claim 3, wherein the holding device comprises a retaining pin for engaging in an opening region provided at the preform, and that a drive mechanism is embodied at the heating chamber for rotating the heating chamber.

10. Furnace according to claim 1, wherein the heating chamber comprises at least one essentially annular or ring segment-shaped external infrared heater for radiating the outer wall of the preform.

11. Furnace according to claim 1, and an axially adjustable and essentially rod-shaped internal infrared heater for radiating the inner wall of the preform.

12. Furnace according to claim 11, wherein the internal infrared heater has an oval cross-section or a polygonal cross-section, and/or further holding devices are provided to hold the internal infrared heaters each eccentric with respect to the main axis of the preform.

13. Furnace according to claim 10, wherein circumferential partial areas with different infrared radiations are embodied at the internal and/or external heater to heat circumferential partial areas of the preform to different degrees.

14. Furnace according to claim 1, wherein the heating chamber comprises at least two chamber segments an operating device for opening and closing the heating chamber by moving the chamber segments apart or towards each other during unloading or loading the heating chambers.

15. Furnace according to claim 1, wherein the heating chambers are circumferentially uniformly arranged at a heating wheel mounted to rotate about an axis of rotation; one recess each radially facing outwards with respect to the axis of rotation is embodied in the side wall of the heating chambers; and a circumferentially surrounding bushing is provided at the furnace which closes the recess in a circumferential partial area of the heating wheel in which each one recess is provided in the bushing, on that the heating chambers are accessible through the recesses of the heating chambers and the bushing for loading them with a preform or withdrawing a preform.

16. Furnace according to claim 1, wherein the heating chambers are circumferentially uniformly arranged at a heating wheel mounted to rotate about an axis of rotation; one recess each radially facing inwards with respect to the axis of rotation is embodied in the side wall of the heating chambers; and a central bushing is provided at the furnace which closes the recess in a circumferential partial area of the heating wheel in which one recess each is provided in the bushing, so that the heating chambers are accessible through the recesses of the heating chambers and the bushing for loading them with a preform or withdrawing a preform.

17. Furnace according to claim 1, and wherein a first heating stage is provided in the form of a first group of heating chambers which rotate in a first circle, and a second heating stage in the form of a second group of heating chambers which rotate in a second circle, and that the holding devices are adapted to hold the preforms during heating in both heating stages.

18. Furnace according to claim 16, wherein the heating chambers and/or the holding devices are adapted to continuously change the rotational position of the preform with respect to the heating chamber during heating in the first heating stage and to adjust it in alignment during heating in the second heating stage, or vice-versa, so that the preform is heated circumferentially essentially uniformly in the first stage with respect to its main axis, and is in the second stage heated to a higher degree in a first direction perpendicular to the main axis than in a second perpendicular direction, or vice-versa.

19. Furnace according to claim 17, wherein the infrared radiation in the heating chambers of the first heating stage is essentially distributed such that axial partial areas of the preforms are heated to different degrees, and in the heating chambers of the second stage such that circumferential partial areas of the preforms are heated to different degrees.

20. Furnace according to claim 16, and a first and a second transport device for circulating transport of the heating chambers of the first or of the second group, respectively, wherein the transport paths of the transport devices each comprise a section which embodies a segment of a common orbit, and that the holding device is arranged on the heating wheel such that they circulate in a circumferential partial section of the heating wheel essentially along the common orbit.

21. Furnace according to claim 2, wherein the oval cross-section is elliptical.

22. Furnace according to claim 2, wherein the oval polygonal cross-section is rectangular.

23. Furnace according to claim 3, wherein the adjustment made is one of continuous change.

24. Furnace according to claim 4, wherein the central drive device comprises meshing gearwheels connected to the holding devices with torque transmission.

25. Furnace according to claim 6, wherein the drive mechanism is one of a circumstantial toothing, a decentralized electric drive, or a combination thereof.

26. Furnace according to claim 8, wherein the drive mechanism is one of a circumstantial toothing, a decentralized electric drive, or a combination thereof.

27. Furnace according to claim 12, wherein the oval cross-section is elliptical.

28. Furnace according to claim 12, wherein the polygonal cross-section is rectangular.

29. Furnace according to claim 13, wherein the different infrared radiations comprise different radiation powers, different spectral radiation behaviors, or a combination thereof.

30. Furnace according to claim 14, wherein the at least two chamber segments are connected by a folding mechanism or a sliding mechanism.

31. Furnace according to claim 15, wherein the circumferential partial area of the heating wheel is between a loading area and a withdrawal area.

32. Furnace according to claim 16, wherein the circumferential partial area of the heating wheel is between a loading area and a withdrawal area.
